(19) United States
(12) Patent Application Publication
(10) Pub. No.: US 2004/0214588 A1
(43) Pub. Date: Oct. 28, 2004

(54) Communication device and communication method

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 10/809,889

(22) Filed: Mar. 26, 2004

(30) Foreign Application Priority Data
Apr. 23, 2003 (JP) 2003-118504

(51) Int. Cl. H04Q 7/20

(52) U.S. Cl. 455/466; 455/414.1

(57) ABSTRACT

An IM server offers instant message service to a communication device, a first client terminal and a second client terminal. When the second client terminal is not logged in the IM server, the first client terminal transmits a first instant message to the communication device. The communication device stores the first instant message. When the second client terminal logs into the IM server, the communication device transmits to the second client terminal, a second instant message generated in accordance with the first instant message. Accordingly, even when a transmission destination is not logged in, the instant message can be transmitted.

### BACKGROUND OF THE INVENTION

1. Field of the Invention

The present invention relates to the technology of an instant message, and more particularly to a device that relays an instant message.

2. Description of the Related Art

Accompanying developments in network technology, many terminals are connected to a network and various pieces of information are transmitted and received. An example of such information is an instant message. The instant message enables a message to be exchanged in real-time and a message can be transmitted and received when the other party of communication is online. However, when the other party of the communication is offline, the message cannot be transmitted and received.

There is a system which promotes the other party of communication to be online by using electronic mail or the like when the other part is offline.

There is another system which notifies an arrival of an instant message by telephone when a terminal of the other party of communication is offline.

Information transmitted and received by using an instant message is required to be the latest information, and there are many cases in which value of the information is lost within a very short period of time. That is, the information handled by the instant message is required to be notified more promptly than information notified by using electronic mail. In addition, importance of the information handled by the instant message is lower than information notified by telephone. Therefore, for example, when electronic mail is transmitted to a user to promote the user to log into an instant message server, some pressure is put on the user.

### SUMMARY OF THE INVENTION

The present invention was made in consideration to the above-described circumstances. An advantage of the present invention is to provide technology for transmitting an instant message in advance to an offline user.

A mode of the present invention is a device that relays an instant message. The device includes a login unit, a reception unit, a storage unit, a detecting unit and a transmission unit. The login unit logs into a server that offers instant message service. The reception unit receives an instant message with a forwarding destination. The storage unit stores the instant message. The detecting unit detects whether or not a user designated as a forwarding destination is logged into the server. The transmission unit transmits the instant message stored in the storage unit to the forwarding destination when the user logs into the server. Accordingly, when the forwarding destination is not logged in the server that offers the instant message service, the device can temporarily store the instant message that is to be transmitted to the forwarding destination. Then, when the forwarding destination logs into the server, the device can transmit the instant message.

The device can further include an adding unit that adds information of a transmitter, which is included in the instant message received by the reception unit, to an instant message to be transmitted to the user that is the forwarding destination. Accordingly, the user of the forwarding destination of the instant message can specify the transmitter of the instant message.

The device can further include a transmission unit. When a prescribed period of time elapses after the receiving unit receives the instant message, the transmission unit transmits an instant message indicating such a fact to the transmitter. Accordingly, information that has become old can be prevented from being forwarded to the forwarding destination.

Any conversion of the combination of the above constituent elements or the expression of the present invention between a method, a device, a system, a recording medium, a computer program or the like is also effective as a mode of the present invention.

### BRIEF DESCRIPTION OF THE DRAWINGS

FIG. 1 is a block diagram of a communication system according to an embodiment of the present invention.

FIG. 2 is a block diagram showing an inner configuration of a communication device of FIG. 1.

FIG. 3 shows an example of a data structure in a transmission contents storage unit of FIG. 2.

### DETAILED DESCRIPTION OF THE PREFERRED EMBODIMENTS

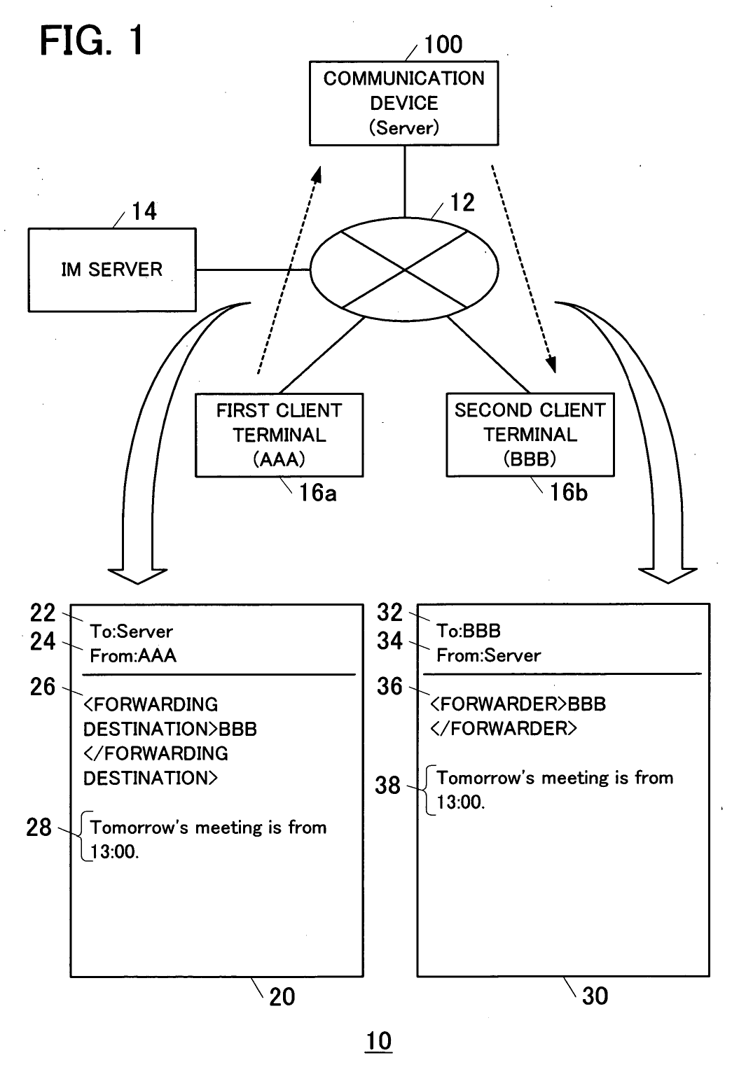

FIG. 1 is a block diagram showing a communication system 10 according to an embodiment of the present invention. The communication system 10 includes a communication device 100 that temporarily stores an instant message. The communication system 10 also includes an instant message server 14 (hereinafter referred to as the “IM server 14”), a first client terminal 16a and a second client terminal 16b. The communication device 100, the IM server 14, the first client terminal 16a and the second client terminal 16b are respectively connected to a network 12. Data can be transmitted and received between each of the terminals via the network 12.

When transmitting an instant message from the first client terminal 16a, in case a transmission destination is not logged in, the communication device 100 temporarily stores the instant message received from the first client terminal 16a. Then, when a client terminal of the transmission destination becomes online, the communication device 100 automatically transmits the temporarily stored instant message to the client terminal.

The IM server 14 is a server for offering instant message service (hereinafter referred to as the “IM service”). For example, the IM service includes service for offering information indicating whether or not a user of the IM service (hereinafter referred to as the “IM user”) can transmit and receive a message (hereinafter referred to as the “presence service”), and service for communicating a message between the IM users (hereinafter referred to as the “message service”). The “instant message” can be a generic name of the presence service and the message service, or can be indicating one of the presence service and the message service. In short, the instant message is information transmitted and received in the IM service. The instant message will be hereinafter referred simply as the “message”. The IM user can use the IM service by using an instant message client terminal (hereinafter referred to as the “IM client terminal”). In the followings, status when the IM user is logged in the IM server 14, in other words, status when the message can be transmitted and received by the IM service, will be referred to as the “active status”.

In the IM service, the message is transmitted and received when the IM user is under the active status. Therefore, the message is immediately notified to the IM client terminal of the IM user, which is a transmission destination, and a push-typed notification can be carried out. The IM server 14 can be an existing server that offers the IM service, or the IM server 14 can be provided newly. As described above, in FIG. 1, the IM server 14 is connected to the network 12.

The first client terminal 16a and the second client terminal 16b are client terminals that log into the IM server 14 to use the IM service. The communication device 100 also includes a function as a client terminal of the IM server 14. In addition, the communication device 100 includes a function for temporarily storing the instant message, and when a transmission destination logs in, transmitting the instant message. In the present embodiment, an instant message address (hereinafter referred to as the “IM address”) of the first client terminal 16a is “AAA”, and the IM address of the second client terminal 16b is “BBB”. The IM address of the communication device 100 is “Server”. The IM address is information for identifying a client terminal in the IM service.

The first client terminal 16a includes a detecting unit for detecting whether or not the second client terminal 16b, which is the transmission destination, is under the active status. For example, the detecting unit can detect whether or not the second client terminal 16b is under the active status by inquiring the IM server 14. When transmitting the instant message, the first client terminal 16a detects whether or not the second client terminal 16b, which is the transmission destination, is under the active status. When the second client terminal 16b is under the active status, the first client terminal 16a transmits the instant message to the second client terminal 16b via the IM server 14, without intervening the communication device 100. When the second client terminal 16b is not under the active status, the first client terminal 16a transmits the instant message to the communication device 100 via the IM server 14. When the communication device 100 receives the instant message that is to be transmitted to the second client terminal 16b, the communication device 100 starts to monitor status of the second client terminal 16b. The communication device 100 monitors the status of the second client terminal 16b by inquiring the IM server 14 as to the status of the second client terminal 16b under a prescribed cycle. When the communication device 100 detects that the second client terminal 16b became under the active status, the communication device 100 immediately transmits to the second client terminal 16b via the IM server 14, the instant message from the first client terminal 16a temporarily stored in the communication device 100.

A first instant message 20 is an example of an instant message transmitted by the first client terminal 16a. The IM address of the communication device 100, which is the transmission destination, is set in a destination column 22. The IM address of the first client terminal 16a is set in a transmitter column 24. A forwarding destination of the instant message is set in a forwarding destination column 26. In FIG. 1, the IM address “BBB” of the second client terminal 16b is set as the forwarding destination. A main text 28 is transmission contents to be notified.

A second instant message 30 is an instant message transmitted from the communication device 100 to the second client terminal 16b. The IM address “BBB” of the second client terminal 16b, which is the transmission destination, is set in a destination column 32. The IM address “Server” of the communication device 100 is set in a transmitter column 34. The IM address “AAA” of the first client terminal 16a, which is a forwarder (forwarding source), is set in a forwarder column 36. A main text 38 is the same character string as the main text 28.

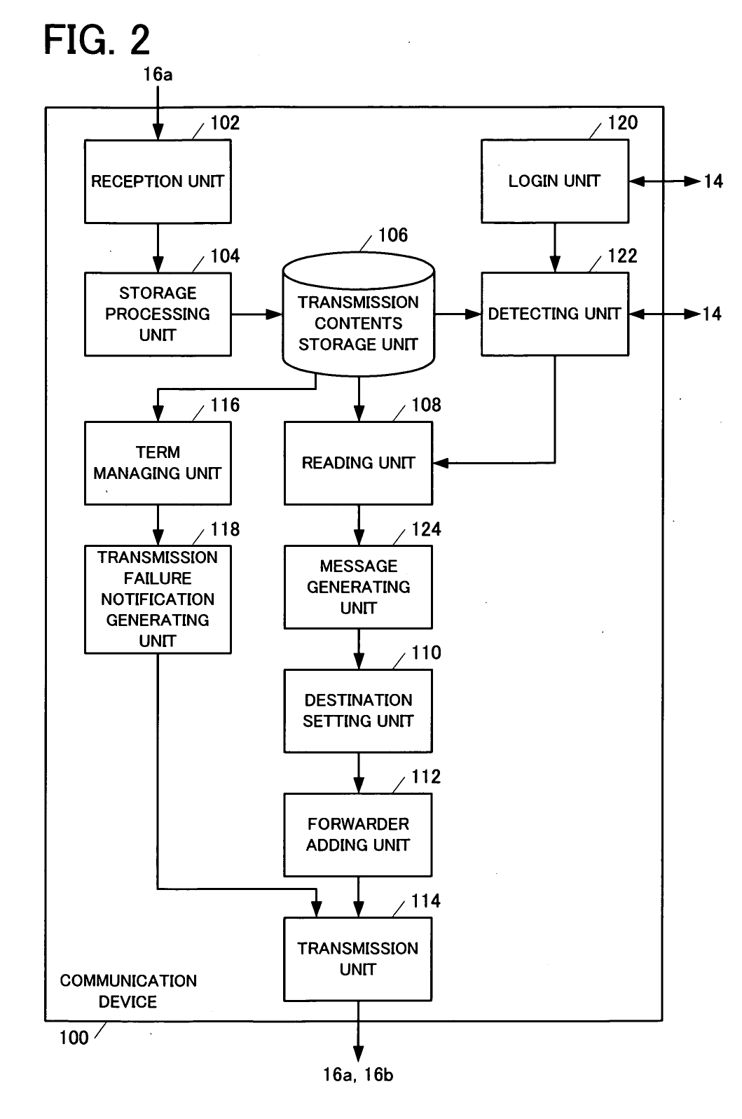

FIG. 2 is a block diagram showing an inner configuration of the communication device 100 of FIG. 1. Each of constituent elements of the communication device 100 is implemented by combinations of hardware and software with a Central Processing Unit (CPU) of a computer, a memory, a program loaded to the memory for implementing the constituent elements of FIG. 2, a storage unit such as hard disk for storing the program, and an interface for establishing a network connection. However, it is to be understood by those skilled in art that there are various variations and modifications to the method and the device for implementing each of the constituent elements of the communication device 100. Each of the drawings to be described hereinafter shows blocks representing units of function, instead of units of hardware.

A login unit 120 establishes a connection with the IM server 14, and performs login process of the IM service to switch the communication device 100 to an active status. For the login process, the login unit 120 stores identification information for using the IM service (hereinafter referred to as the “login ID”) and password or the like. Such information necessary for the login process will be referred to as the “login information”. The login unit 120 can store the login information in advance or can accept a setting from a manager of the communication device 100 or the like. When supporting a plurality of IM services, the login unit 120 stores login information for each of the IM services.

Although the details will be described later, a transmission contents storage unit 106 stores information of a user to become a forwarding destination of the instant message (hereinafter referred to as the “reception user”) and transmission contents or the like. After the login is completed by the login unit 120, a detecting unit 122 inquires the IM server 14 as to whether or not the reception user stored in the transmission contents storage unit 106 is under the active status. The detecting unit 122 can detect whether or not the reception user is under the active status with reference to a response from the IM server 14.

A reception unit 102 receives the first instant message 20 from the first client terminal 16a and outputs the first instant message 20 to a storage processing unit 104. The storage processing unit 104 divides the received first instant message 20 into the IM address of the forwarding destination, the IM address of the forwarder and the transmission contents and stores in the transmission contents storage unit 106.

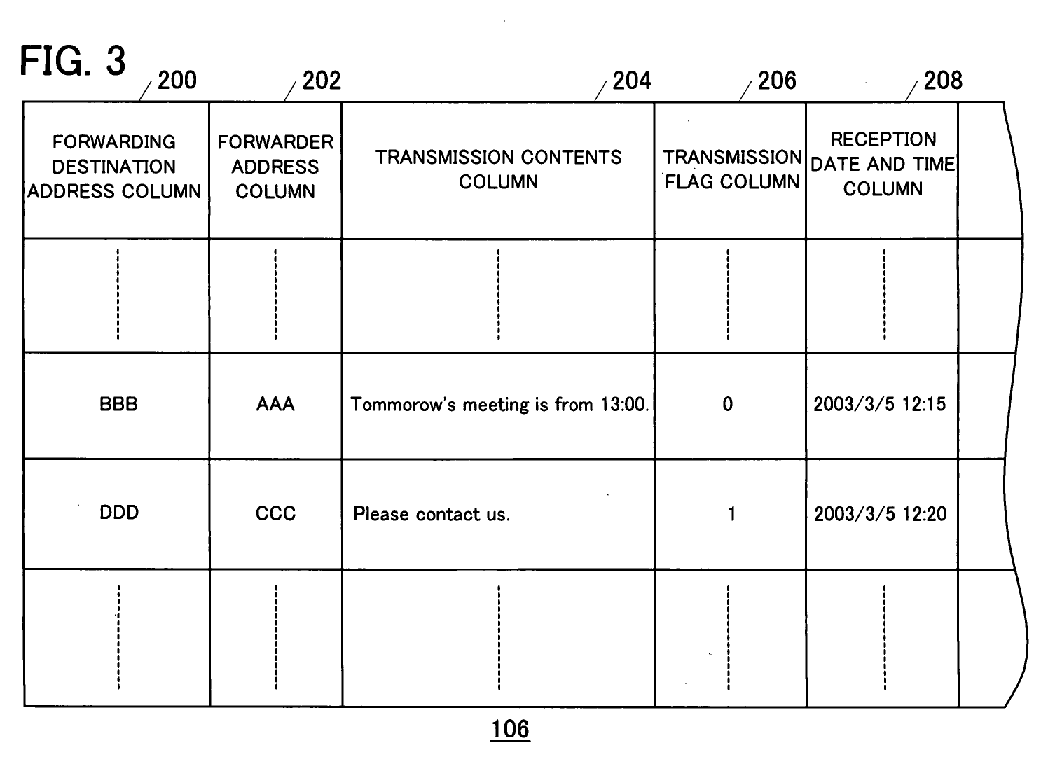

FIG. 3 shows an example of a data structure in the transmission contents storage unit 106 of FIG. 2. A forwarding destination address column 200 stores the IM address set in the forwarding destination column 26 of the first instant message 20. A forwarder address column 202 stores the IM address set in the transmitter column 24 of the first instant message 20. A transmission contents column 204 stores character strings set in the main text column 28 of the first instant message 20. A transmission flag column 206 stores information designating whether or not the second instant message 30 is transmitted. In FIG. 3, “1” indicates that the second instant message 30 is already transmitted and “0” indicates that the second instant message 30 is not yet transmitted. A reception date and time column 208 stores reception date and time of the first instant message 20.

Returning to FIG. 2, when the detecting unit 122 detects that the user stored in the forwarding destination address column 200 of FIG. 3 became under the active status, the detecting unit 122 outputs the IM address of the user to a reading unit 108. Instead of the IM address, the login ID can be output to the reading unit 108. In short, the detecting unit 122 outputs to the reading unit 108, information specifying the user that became under the active status. The reading unit 108 reads the transmission contents associated to the IM address from the transmission contents storage unit 106 and outputs to a message generating unit 124. The message generating unit 124 generates the second instant message 30 including the transmission contents.

A destination setting unit 110 sets the IM address stored in the forwarding destination address column 200 of FIG. 3 as a destination of the second instant message 30. A forwarder adding unit 112 sets the IM address stored in the forwarder address column 202 as the forwarder in the forwarder column 36 of the second instant message 30. A transmission unit 114 transmits the generated second instant message 30 to the second client terminal 16b. Accordingly, the communication device 100 can temporarily store the first instant message 20 received from the forwarder, and when the user of the forwarding destination becomes under the active status, the communication device 100 can transmit the second instant message 30 to the user of the forwarding destination.

A term managing unit 116 determines whether or not a prescribed term has elapsed in accordance with the reception date and time column 208 for not yet transmitted message stored in the transmission contents storage unit 106 (instant message which transmission is not completed). When the prescribed term has elapsed, the term managing unit 116 instructs a transmission failure notification generating unit 118 to generate an instant message notifying that the second instant message 30 cannot be transmitted (hereinafter referred to as the “transmission failure notification”). The transmission failure notification generating unit 118 generates a transmission failure notification and sets as the destination, the IM address of the first client terminal 16a, which is the transmitter of the first instant message 20. Then, the transmission failure notification generating unit 118 outputs the transmission failure notification to the transmission unit 114. The transmission unit 114 transmits the transmission failure notification to the first client terminal 16a. As described above, by carrying out the transmission failure notification according to the term, the user of the first client terminal 16a can be notified that the second instant message 30 failed to be transmitted to the second client terminal 16b even after an elapse of the prescribed term.

A preferred embodiment of the present invention has been described. The above-described embodiment is an example, and it is to be understood by those skilled in art that there are variations to combination of each of the constituent elements and processes, and those variations also fall within the scope of the present invention.

What is claimed is:

1. A communication device comprising:
means for logging into a server that offers instant message service;
means for receiving an instant message having a forwarding destination;
means for storing the instant message;
means for detecting whether or not a user designated as the forwarding destination is logged in the server; and
means for transmitting to the forwarding destination, the instant message stored in the means for storing when the user logs into the server.

2. The communication device according to claim 1, further comprising:
means for adding to an instant message to be transmitted to the user, information of a transmitter included in the instant message received by the means for receiving.

3. The communication device according to claim 2, further comprising:
means for transmitting to the transmitter, when a prescribed period of time elapses after the means for receiving receives the instant message, an instant message indicating such a fact.

4. The communication device according to claim 1, wherein the means for detecting detects whether or not the user is logged in the server by inquiring the server.

5. The communication device according to claim 1, wherein the means for receiving receives a first instant message including a transmission destination, a transmitter, a forwarding destination and a main text.

6. The communication device according to claim 5, further comprising:
means for generating a second instant message including a transmission destination, a transmitter, a forwarder and a main text in accordance with the first instant message.

7. A communication device comprising:
means for logging into a server that offers instant message service;
means for receiving from a client terminal of a forwarder, an instant message including identification information of a client terminal of a forwarding destination;
means for storing the instant message;
means for detecting whether or not the client terminal of the forwarding destination is under active status; and
means for transmitting the instant message stored in the means for storing to the client terminal of the forwarding destination when the client terminal of the forwarding destination is under the active status.

8. The communication device according to claim 7, further comprising:
means for adding to an instant message to be transmitted to the client terminal of the forwarding destination, information of a transmitter included in the instant message received from the client terminal device of the forwarder by the means for receiving.

9. The communication device according to claim 7, further comprising:
means for transmitting to the client terminal of the forwarder, when a prescribed period of time elapses after the means for receiving receives the instant message and the instant message fails to be transmitted to the client terminal of the forwarding destination, an instant message indicating such a fact.

10. The communication device according to claim 7, wherein the means for detecting detects whether or not the client terminal of the forwarding destination is under the active status by inquiring the server.

11. The communication device according to claim 7, wherein the means for receiving receives from the client terminal of the forwarder, a first instant message including identification information of the communication device as transmission destination information, identification information of the client terminal of the forwarder as transmitter information, identification information of the client terminal of the forwarding destination as forwarding destination information, and main text.

12. The communication device according to claim 11, further comprising:
means for generating a second instant message including the identification information of the client terminal of the forwarding destination as transmission destination information, the identification information of the communication device as transmitter information, the identification information of the client terminal of the forwarder as forwarder information, and main text, in accordance with the first instant message;
wherein when the client terminal of the forwarding destination is under the active status, the means for transmitting transmits the second instant message to the client terminal of the forwarding destination.

13. A communication method comprising the steps of:
detecting by a terminal of a forwarder, whether or not a user of a terminal of a forwarding destination is logged in an instant message server;
transmitting an instant message including identification information of the terminal of the forwarding destination from the terminal of the forwarder to a communication device when the user of the forwarding destination is not logged in the instant message server;
storing the instant message received from the terminal of the forwarder in means for storing of the communication device;
detecting by the communication device, whether or not the user of the forwarding destination designated as the terminal of the forwarding destination is logged in the instant message server; and
transmitting the instant message stored in the means for storing from the communication device to the terminal of the forwarding destination when the user of the forwarding destination logs into the instant message server.

14. The communication method according to claim 13, further comprising the step of:
adding to an instant message to be transmitted from the communication device to the terminal of the forwarding destination, transmitter information included in the instant message which the communication device received from the terminal of the forwarder.

15. The communication method according to claim 13, further comprising the step of:
transmitting, when a prescribed period of time elapses after the communication device receives the instant message from the terminal of the forwarder, an instant message indicating such a fact from the communication device to the terminal of the forwarder.

16. The communication method according to claim 13, further comprising the step of:
transmitting the instant message from the terminal of the forwarder to the terminal of the forwarding destination without intervening the communication device when the user of the forwarding destination is logged in the instant message server.

17. The communication method according to claim 13, further comprising the step of:
detecting whether or not the user of the forwarding destination is logged into the instant message server by inquiring the instant message server.

18. The communication method according to claim 13, further comprising the step of:
receiving a first instant message including a transmission destination, a transmitter, a forwarding destination and main text from the terminal of the forwarder.

19. The communication method according to claim 18, further comprising the step of:
generating a second instant message including a transmission destination, a transmitter, a forwarder and main text as an instant message to be transmitted to the terminal of the forwarding destination in accordance with the first instant message.
